(19) United States
(12) Patent Application Publication
(10) Pub. No.: US 2025/0218715 A1
(43) Pub. Date: Jul. 3, 2025

(54) RELAY

(71) Applicant: FCL Components Limited, Tokyo (JP)

(72) Inventor: Takaki Sunohara, Tokyo (JP)

(21) Appl. No.: 18/988,412

(22) Filed: Dec. 19, 2024

(30) Foreign Application Priority Data
Dec. 28, 2023 (JP) 2023-223697

(51) Int. Cl. H01H 50/44

(52) U.S. Cl. CPC H01H 50/44; H01H 2050/446

(57) ABSTRACT

An electromagnetic relay with high insulation while minimizing increases in size and the number of parts is provided. The electromagnetic relay has a coil, a bobbin around which the coil is wound, an iron core inserted into the bobbin, an electromagnet having a yoke forming a magnetic circuit with the iron core, a movable terminal having a movable contact configured to move with the operation of the electromagnet, fixed terminals having fixed contacts positioned opposed to the movable contact, a coil terminal attached to the bobbin and connected to the coil, an insulating member positioned between the coil and the yoke, and a base having a wall part configured to insulate between the coil terminal and the fixed terminals.

### CROSS-REFERENCE TO RELATED APPLICATIONS

This application is based upon and claims the benefit of priority of the prior Japanese Patent Application No. 2023-223697 filed on Dec. 28, 2023, the entire contents of which are incorporated herein by reference.

### TECHNICAL FIELD

The present disclosure relates to a relay.

### BACKGROUND

A relay (electromagnetic relay) is configured to flow a current through a coil to open and close contacts. There is a hinge-shaped relay which has a yoke connected to an iron core and an armature movable relative to the yoke.

In a relay having a coil and a yoke, a technique for insulating the coil from the yoke by providing an insulating material therebetween is well known. Further, there is known a technique for increasing an insulation distance between the coil and an electronic component by providing a flange portion to a bobbin around which the coil is wound.
[Patent Literature 1] JP 2014-049315 A
[Patent Literature 2] JP 2017-027877 A
[Patent Literature 3] JP 2009-009710 A
[Patent Literature 4] JP 2023-051496 A
[Patent Literature 5] JP 2023-051497 A
[Patent Literature 6] JP 2023-051498 A

### SUMMARY

In a relay used in low-voltage applications, high electrical insulation performance between components thereof is not as required. However, in a relay capable of handling a high voltage and a high current, used in an on-board charger for an electric vehicle, etc., high insulation performance is required. Methods for improving the insulation performance include increasing the physical distance between the components or placing an insulating material between the components, but the former method has the problem of increasing the size of the relay, and the latter method has the problem of increasing the number of parts.

Therefore, there is a need for a relay which can minimize increases in size and number of components, while achieving high insulation performance.

One aspect of the present disclosure is a relay comprising: an electromagnet including a coil, a bobbin around which the coil is wound, an iron core inserted in the bobbin, and a yoke forming a magnet circuit together with the iron core; a movable terminal having a movable contact configured to be moved corresponding to an activation of the electromagnet; a fixed terminal having a fixed contact positioned opposed to the movable contact; a coil terminal attached to the bobbin and connected to the coil; an insulating member positioned between the coil and the yoke; and a base having a wall configured to insulate between the coil terminal and the fixed terminal.

### BRIEF DESCRIPTION OF DRAWINGS

FIG. 1 is a perspective view of a relay according to an embodiment;

FIG. 2 is an exploded perspective view of the relay;

FIG. 3 is a perspective view of a structural example of an insulating member;

FIG. 4 is a view of the insulating member of FIG. 3 viewed from a different angle

FIG. 5 is a cross-sectional view along an A-A line of FIG. 3;

FIG. 6 is a cross-sectional view along an A′-A′ line of FIG. 1;

FIG. 7 is a cross-sectional view along an A″-A″ line of FIG. 6;

FIG. 8 is a view showing an example of a connection between a bobbin and the insulating member;

FIG. 9 is a view showing an example of a caulking position of a yoke relative to a movable spring.

FIG. 10 is a perspective view showing a state in which the bobbin and the insulating members are combined;

FIG. 11 is a perspective view of a structural example of the bobbin;

FIG. 12 is a view of the bobbin of FIG. 11 viewed from a different angle;

FIG. 13 is a view of the bobbin of FIG. 11 viewed in a front-back direction;

FIG. 14 is a view of the bobbin of FIG. 11 viewed in a width direction;

FIG. 15 is a view of the bobbin of FIG. 11 viewed in a height direction;

FIG. 16 is a perspective view of a structural example of a base;

FIG. 17 is a view of the base viewed in the height direction;

FIG. 18 is a cross-sectional view along an F-F line of FIG. 17; and

FIG. 19 is a perspective view of a relay having a 1a contact configuration.

### DESCRIPTION

Hereinafter, a description will be given of an embodiment of the present disclosure with reference to the drawings.

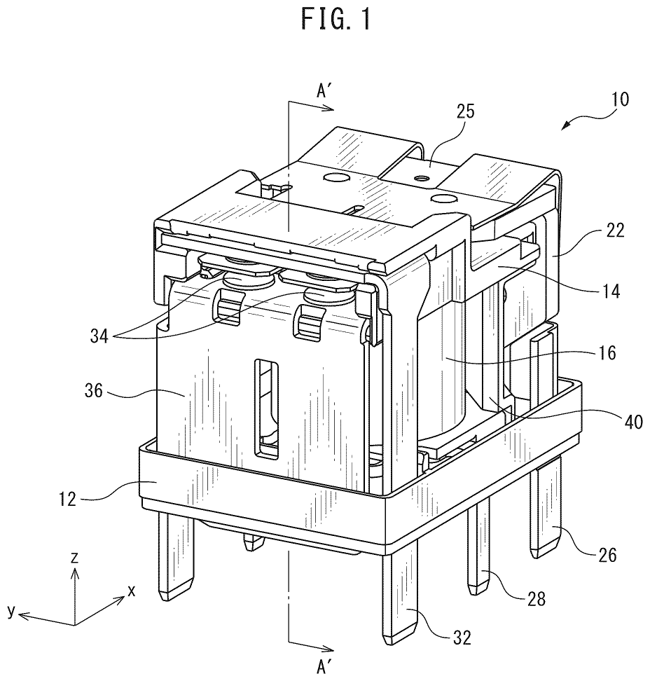

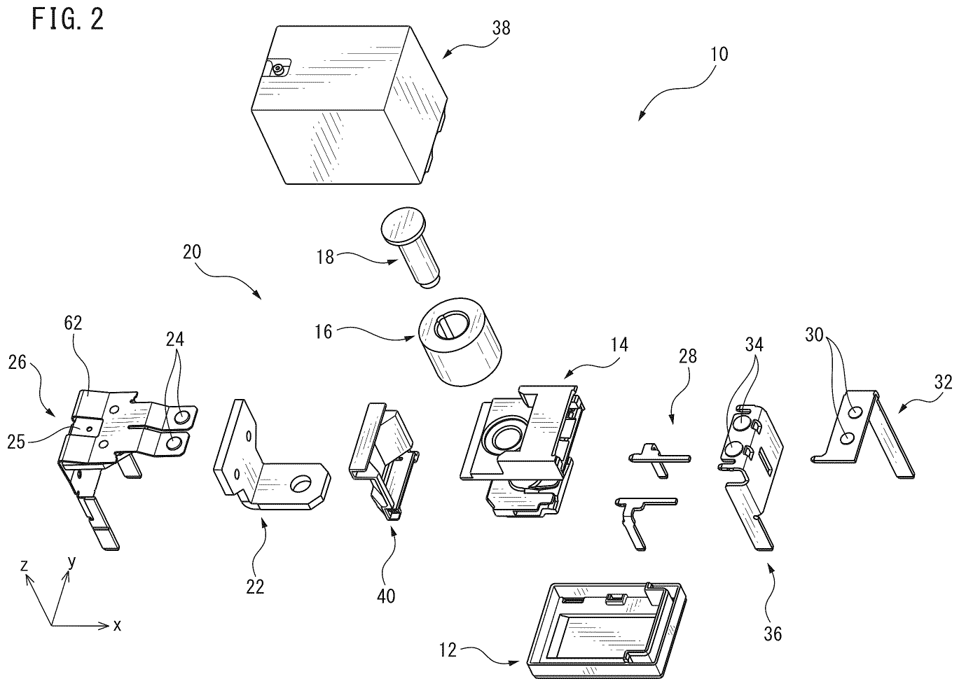

FIG. 1 is a perspective view of a relay 10 according to an embodiment, and FIG. 2 is an exploded perspective view of FIG. 1. The relay 10 is used, for example, in an on-board charger, and has a base 12 and an electromagnet 20 attached to the base 12. The electromagnet 20 includes a bobbin 14, a coil 16 wound around the bobbin 14, an iron core 18 positioned within the bobbin 14, and a substantially L-shaped yoke 22 coupled to one end of the iron core 18 so as to form a magnetic circuit with the iron core 18. The relay 10 also has an armature 25 configured to be attracted to a head (the other end) of the iron core 18 when the electromagnet 20 is actuated, a movable terminal 26 having two movable contacts 24, which is moved in a direction toward and away from the head of the iron core 18 in response to the motion of the armature 25, and two coil terminals 28 connected to both ends of the coil winding 16. In the illustrated example, the coil terminals 28 are attached to the bobbin 14. The movable contacts 24 are attached near a front end of the movable spring.

The relay 10 has a fixed terminal having a fixed contact arranged opposed to the movable contact 24. The relay 10 is a so-called 1c contact configuration relay, and has a first fixed terminal (break terminal) 32 having two fixed break contacts 30 and a second fixed terminal (make terminal) 36 having two fixed make contacts 34, as fixed terminals. In the illustrated example, the first fixed terminal 32 and the second fixed terminal 34 are each attached to the bobbin 14. The movable contact 24 contacts the normally closed fixed contact 30 when the electromagnet 20 is OFF, and contacts the normally open fixed contact 34 when the electromagnet 20 is ON. Each of the movable terminal 26, the break terminal 32, and the make terminal 36 has two contacts, so that the relay 10 has high current carrying performance. The relay 10 can be assembled manually, or automatically using an assembly machine, etc.

The relay 10 has a cover 38 configured to fit into the base 12 and cooperate with the base 12 so as to contain the above-described components, and an insulating member 40 configured and arranged to provide electrical insulation between the coil 16 and the yoke 22. To clarify the components of the relay 10, the cover 38 is omitted from FIG. 1. Of the above-described components, the base 12, the bobbin 14, the cover 38, and the insulating member 40 are made of an electrically insulating resin material, and can be molded by, for example, injection molding.

In the present embodiment, a height direction parallel to an axial direction of the iron core 18 is called a z-direction, a width direction perpendicular to the z-direction and in which the two movable contacts 24 or the two fixed contacts 30 or 34 are arranged is called a y-direction, and a front-back direction perpendicular to both the y-direction and the z-direction is called an x-direction.

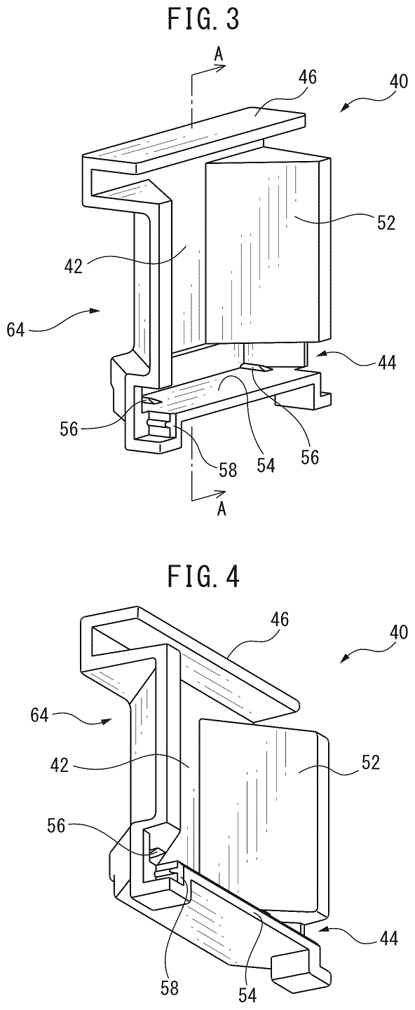

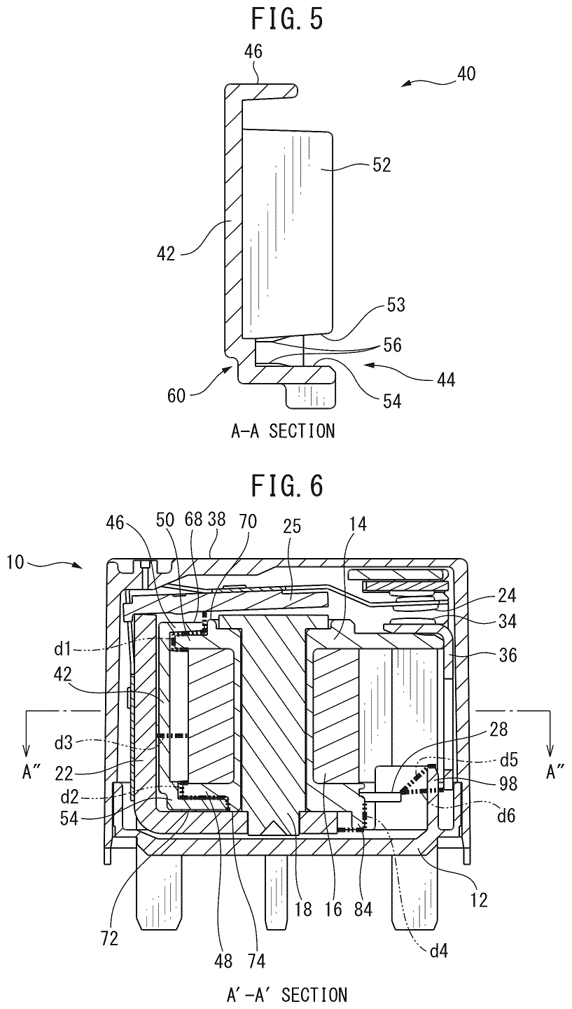

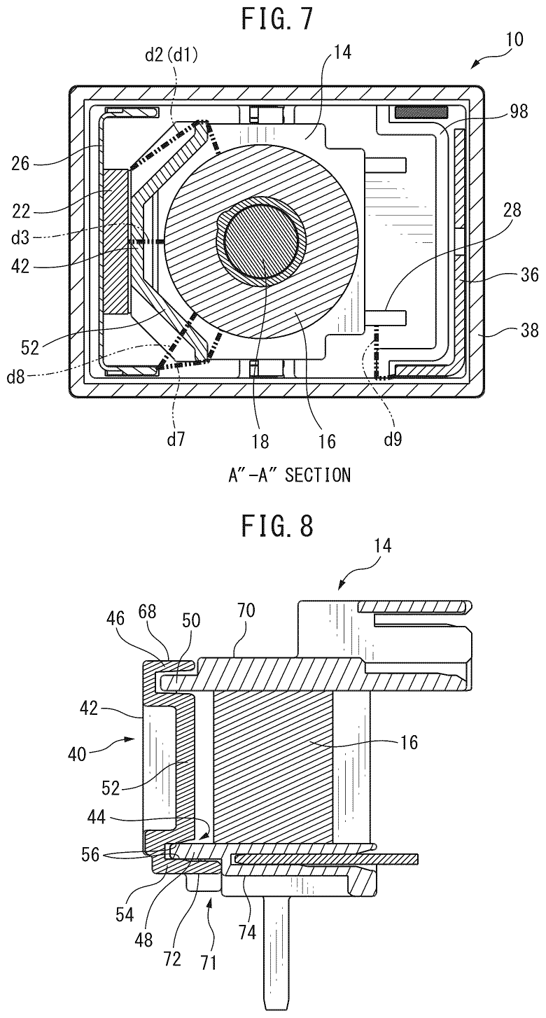

FIG. 3 is a perspective view showing a structural example of the insulating member 40, FIG. 4 is a perspective view of the insulating member 40 viewed from a different direction from that of FIG. 3, and FIG. 5 is a cross-sectional view along a line A-A in FIG. 3. Further, FIG. 6 is a cross-sectional view along a line A′-A′ parallel to the z-direction in FIG. 1, and FIG. 7 is a cross-sectional view along a line A″-A″ perpendicular to the z-direction in FIG. 6.

The insulating member 40 is positioned between the coil 16 and the yoke 22, and has a wall 42 extending substantially in the z-direction, a fitting part 44 arrange at a lower part of the wall 42, i.e., on a side opposed to the contact, into which a lower flange part 48 of the bobbin 14 fits, and a canopy 46 arranged at an upper portion of the wall 42 and covering an upper flange part 50 of the bobbin 14. The insulating member 40 further has a protrusion 52 extending from the wall 42 in a substantially tangential direction of the coil 16.

The insulating member 40 is fixed to the bobbin 14 by inserting the lower flange part 48 into the fitting part 44 by press-fitting, etc. The fitting part 44 is defined by a lower surface of the protrusion 52 and a bottom part 54 formed below the protrusion 52 and spaced apart therefrom. In this case, in order to smoothly fit the lower flange part 48 into the fitting part 44, as shown in FIG. 5, it is preferable that a lower end 53 of the protrusion 52 has a tapered shape which narrows in width from the right side to the left side in the figure with respect to the direction perpendicular to the z-direction. In addition, it is preferable that each of the bottom part 54 and the lower end 53 has a rib 56 configured to guide the lower flange part 48 when it is inserted. As shown in FIG. 8, the lower flange part 48 inserted into the fitting part 44 is sandwiched between the ribs 56 arranged above and below it, so that the ribs 56 can more reliably fix the fitting part 44 and the lower flange part 48.

As shown in FIGS. 6 and 7, by disposing the insulating member 40 according to the present embodiment between the coil 16 and the yoke 22, it is possible to make insulation distances d1 and d2 between the coil 16 and the yoke 22 or the armature 25 significantly longer than an insulation distance d3 assumed when the insulating member 40 is not present. Further, by providing the protrusion 52 to the insulating member 40, it is possible to make an insulation distance d7 between the coil 16 and the movable terminal 26 significantly longer than an insulation distance d8 assumed when the protrusion 52 is not present, as shown in FIG. 7.

As shown in FIG. 8, in order to make the fitting between the insulating member 40 and the bobbin 14 stronger, a recessed fitting part 71 may be formed on the bobbin 14, and a taper 58 as shown in FIGS. 3 and 4 may be formed on the bottom part 54 of the insulating member 40.

The insulating member 40 contacts the bobbin 14 only at the fitting part 44, and does not contact the upper flange part 50 of the bobbin 14. Therefore, the canopy 46 of the insulating member 40 covers the upper flange part 50 and functions to increase the insulation distance between the coil 16 and the yoke 22, but does not contact the upper flange part 50. For example, as shown in FIG. 5, the canopy 46 may have a tapered shape which tapers away from the wall 42 so as to more reliably avoid the contact between the canopy 46 and the upper flange part 50.

Since the insulating member 40 does not contact the bobbin 14 at any part other than the fitting part 44, any component other than the fitting part 44 and the lower flange part 48 does not slide against the other component when the relay 10 is assembled. In the relay, chips, etc., are generated due to the press-fitting and sliding between the components during assembly, and the opening/closing motion of the contact may be adversely affected due to the chips, etc. However, in the present embodiment, the amount of chips generated is limited by positioning the part where chips, etc., may be generated due to the sliding away from the contact, and the generated chips do not adversely affect the motion of the relay. In this way, since the insulating member 40 contacts the bobbin 14 only at the lower part of the relay 10, while the movable contacts and the fixed contacts are arranged at the upper part of the relay 10, when chips are generated at the lower part of the relay, factors which may cause malfunctions of the relay, such as chips entering between the movable contacts and the fixed contacts arranged at the upper part of the relay, can be reduced.

When the wire forming the coil 16 is wound around the bobbin 14, the lower flange part 48 or the upper flange part 50 may warp. Therefore, when both the lower flange part 48 and the upper flange part 50 are fixed to other components, there is a risk that the bobbin will interfere with the other components during assembly, making the assembly difficult. However, in the present embodiment, the upper flange part 50 is configured to have a gap without contacting the other components, so that even when the upper flange part 50 is warped, interference between the upper flange part 50 and other components can be prevented.

As described above, since the insulating member 40 fits with the bobbin 14 at the fitting part 44, it is desirable to prevent distortion of the lower part of the insulating member 40 during molding. Therefore, it is preferable that a part of the insulating member 40 constituting the fitting part 44 has a constant thickness. By making the thickness constant, it is possible to limit the distortion during, for example, injection molding.

When the yoke 22 is formed by bending a metal plate, there is a risk that the bent yoke 22 may come into contact with the insulating member 40. Therefore, as shown in FIG. 5, it is preferable that the insulating member 40 has a relief part 60 in order to avoid contact with a portion of the yoke 22 which corresponds to an inner bend radius R.

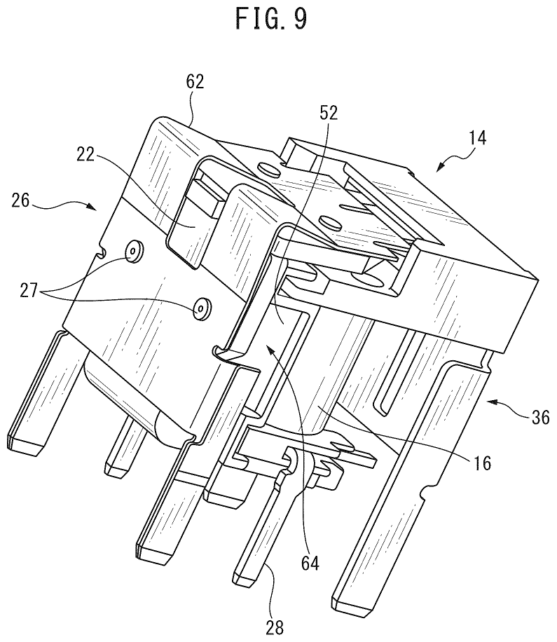

In assembling the relay 10, when the movable spring 62 is caulked to the yoke 22 at a position 27 as illustrated in FIG. 9, it may be necessary to insert a jig on the back side of the yoke 22 corresponding to the position 27. However, depending on the shape of the insulating member, it may be difficult or impossible to insert the jig. Therefore, it is preferable that the insulating member 40 has a recess 64 on the side of the protrusion 52 facing the yoke 22, as shown in FIGS. 3 and 4. In FIG. 7, the insulating member 40 with the recess 64 formed therein has a substantially V-shape when viewed from above, and a space for inserting the jig can be secured between the insulating member 40 and the yoke 22.

As shown in FIG. 6, the canopy 46 has a shape which projects in the x-direction and toward the contact (the right side in FIG. 6) so as to increase the insulation distance between the coil 16 and the yoke 22. Further, as shown in a part “B” in FIG. 10, the canopy 46 may have an extending part 66 which projects in the y-direction beyond the upper flange part 50 to an extent that does not contact the cover 38. The extending part 66 can further increase the insulation distance between the coil 16 and the yoke 22.

The insulating member 40 preferably has a structure for preventing malfunction of the relay 10 and facilitating assembly of the relay 10. For example, as shown in FIG. 8, it is preferable that an upper end surface 68 of the canopy 46 is located at a position slightly lower than an upper end 70 of the bobbin 14, on the opposite side of the contact in the z-direction. When the upper end surface 68 extends above the upper end 70, the armature 25 may come into contact with the upper end surface 68 during operation, causing malfunction of the relay 10. However, by configuring as shown in FIG. 8, the contact between the armature 25 and the upper end surface 68 can be prevented. Further, it is preferable that a lower end surface 72 of the bottom 54 is located at a position slightly higher than a lower end 74 of the bobbin 14, on the contact side in the z-direction. In this way, it is possible to prevent contact between the yoke 22 and the lower end surface 72 during assembly of the relay 10, making the assembly easier.

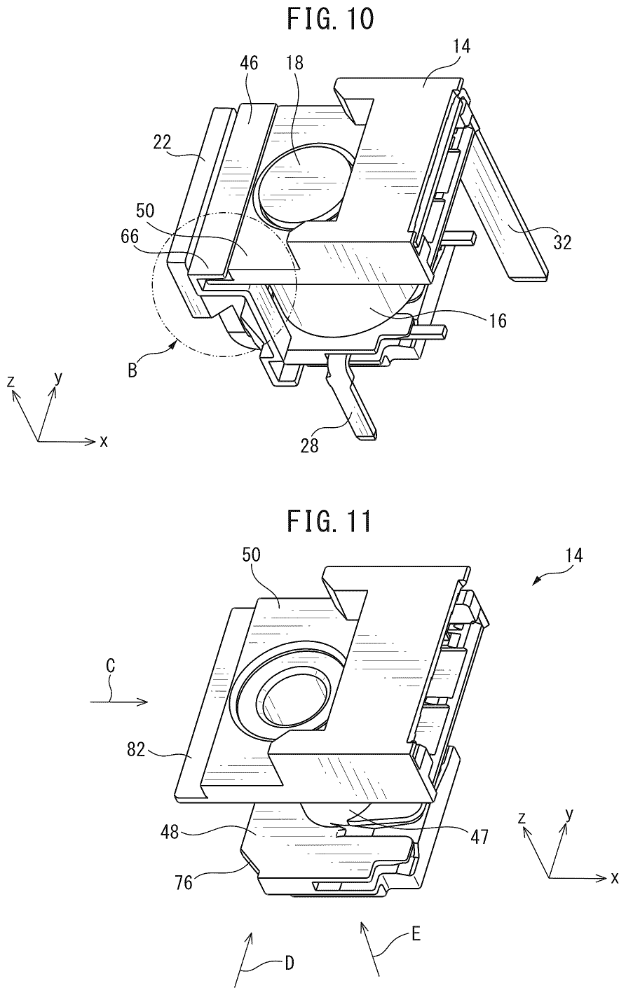

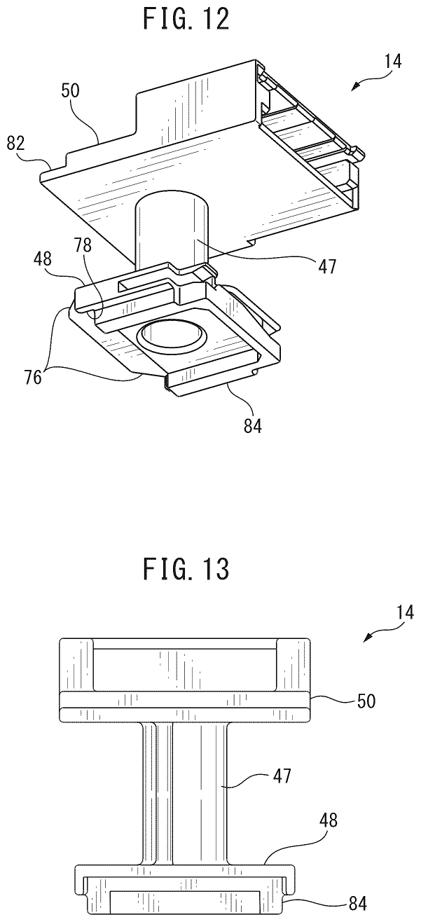

FIG. 11 is a perspective view showing a structural of the bobbin 14, and FIG. 12 is a perspective view of the bobbin 14 viewed from a different direction from that of FIG. 11. Also, FIGS. 13 to 15 are a front view viewed along a direction C parallel to the x-direction in FIG. 11, a side view viewed along a direction D parallel to the y-direction, and a bottom view of the bobbin 14 viewed along a direction E parallel to the z-direction, respectively.

The bobbin 14 has a hollow cylindrical body 47 around which the coil 16 is wound, and the lower flange part 48 and the upper flange part 50 formed on both longitudinal ends of the body 47. When the relay 10 has been assembled, the lower flange part 48 is received in the base 12, the body 47 extends in the z-direction relative to the base 12, and the upper flange part 50 is positioned above the base 12 and approximately parallel to the lower flange part 48. Each of the lower flange part 48 and the upper flange part 50 is a substantially rectangular plate-like element which projects from the body 47 in a direction parallel to the x-y plane and approximately perpendicular to the longitudinal direction of the body 47.

As described above, the lower flange part 48 is fitted to the insulating member 40 by press-fitting, etc., into the fitting part 44. Therefore, it is preferable that the lower flange part 48 has a taper 76, by which the lower flange part can be easily inserted 48 into the fitting part 44. Also, as shown in FIGS. 12 and 15, it is preferable that the lower flange part 48 has a taper 78 configured to abut against and guide the taper 58 in order that the taper 58 can be easily inserted into the fitting part 71.

The lower flange part 48 has functions such as preventing fraying of the windings forming the coil 16, fixing the insulating member 40, and ensuring the insulation distance between the coil 16 and the yoke 22. In this regard, in order to further extend the insulation distances between the coil 16 and the yoke 22 and between the coil 16 and the armature 25, the lower flange part 48 may have a step part 80 extending forward in the x-direction toward the yoke 22. Similarly, the upper flange part 50 may have a step part 82 extending forward in the x-direction toward the yoke 22. By virtue of the step parts 80, 82 extending in the x-direction, the insulation distances d1, d2 as shown in FIG. 6 can be further extended.

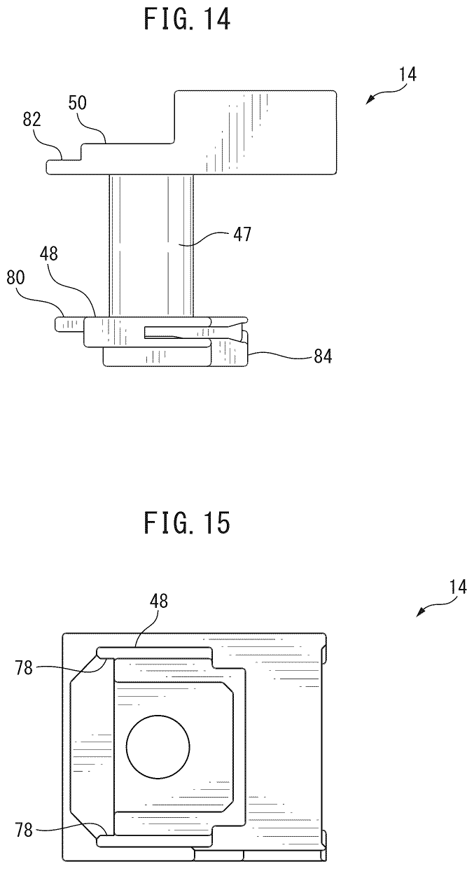

Further, as shown in FIGS. 13 and 14, the lower flange part 48 may have a wall 84 for ensuring the insulation distance between the coil 16 and the yoke 22. By virtue of the wall 84, a longer insulation distance d4 can be obtained between the coil 16 and the yoke 22, as compared to the case where there is no wall 84 as shown in FIG. 6.

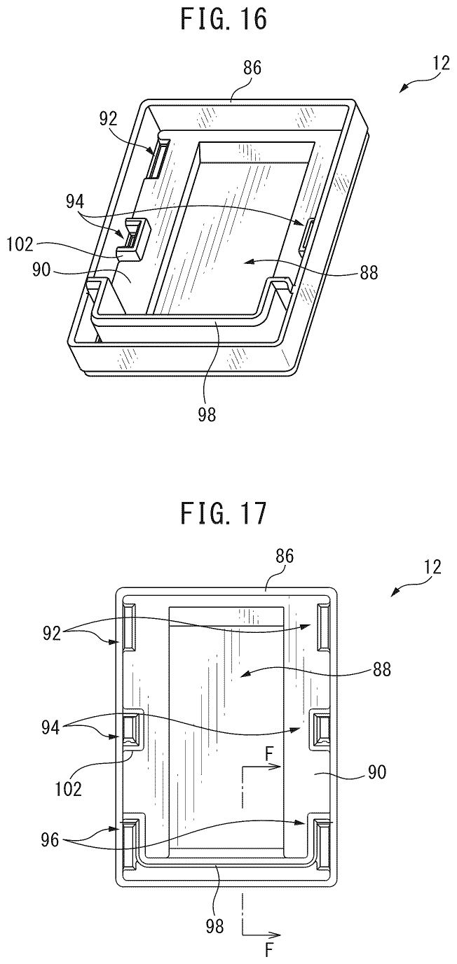

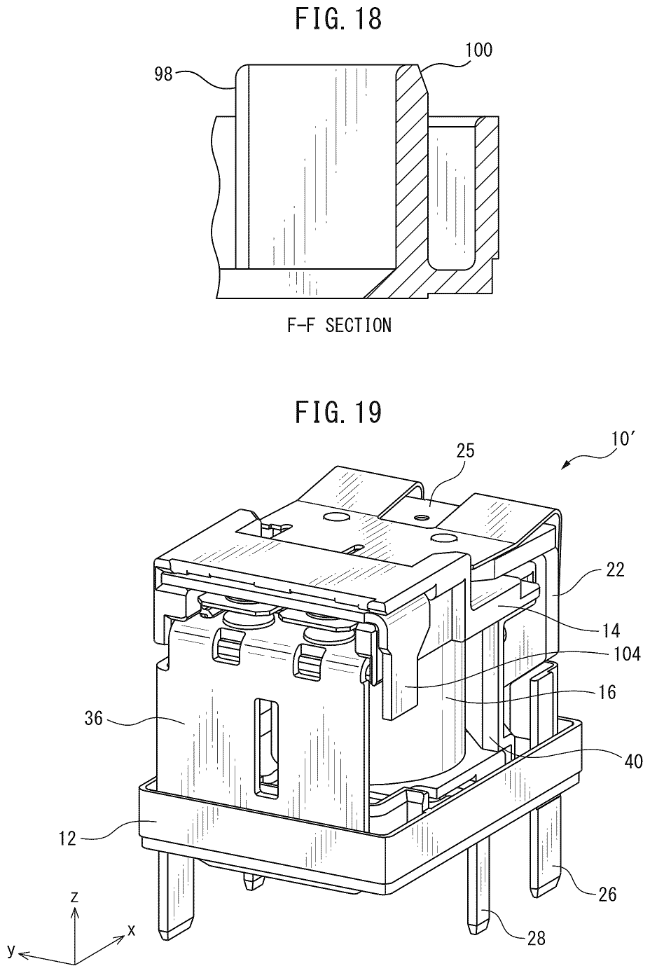

FIG. 16 is a perspective view showing a structural example of the base 12, FIG. 17 is a perspective view of the base 12 viewed from above in the z-direction, and FIG. 18 is a cross-sectional view along a line F-F in FIG. 17. The base 12 has a frame part 86 extending into a substantially rectangular outline as viewed from above, and a bottom part 90 which partially closes an opening part 88 defined by a lower end of the frame part 86. The base 12 is configured to receive the components of the relay 10 and fix them in place.

In the bottom part 90 of the base 12, a first hole 92 through which the movable terminal 26 as shown in FIG. 2, etc., is inserted, a second hole 94 through which the coil terminal 28 is inserted, and a third hole 96 through which the fixed terminals 32, 36 are inserted are formed. The base 12 also has a wall 98 for ensuring the insulation distance between the coil terminal 28 and the fixed terminals 32, 36. The wall 98 has a substantially U-shape as viewed from above, extending upward in the z-direction from the bottom 90, and is positioned adjacent to the third hole 96 so as not to interfere with the assembly of other components.

As shown in FIG. 6, by arranging the wall 98, it is possible to ensure an insulation distance d5 between the coil terminal 28 and the fixed terminal 36, which is longer than the insulation distance d6 assumed when the wall 98 is not present. Further, because the shape of the wall 98 is substantially U-shaped as viewed from the above, it is possible to ensure a relatively long insulation distance d9 between the coil terminal 28 and the fixed terminal 36, as shown in FIG. 7.

Since the wall 98 can be integrally formed as a part of the base 12 by injection molding of resin, etc., the number of components of the relay 10 is not increased even when the wall 98 is provided. Further, it is not necessary to increase the size of the base 12 in order to form the wall 98. Thus, according to the present embodiment, the relay 10 is provided, in which the relatively long insulation distance can be ensured between the coil terminal 28 and the fixed terminal 36 without increasing the size or the number of component.

As shown in FIG. 18, the wall 98 may have a tapered guide 100 for facilitating the insertion of the fixed terminal 36 during assembly of the relay 10. The guide 100 also functions to improve the positioning accuracy of the fixed terminal 36.

In the above example, the relay 10 has a so-called 1c contact configuration, which has the break terminal 32 with the fixed contact, but the application of the present disclosure is not limited to this. For example, the present disclosure can be similarly applied to a relay having a so-called 1a contact configuration, which has a backstop 104 without a fixed contact, instead of a break terminal, such as a relay 10′ as shown in FIG. 19.

According to the present disclosure described above, it is possible to provide a relay which can insulate between each component while suppressing an increase in the number of parts and achieving a miniaturized relay.

What is claimed is:

1. A relay comprising:
an electromagnet including a coil, a bobbin around which the coil is wound, an iron core inserted in the bobbin, and a yoke forming a magnet circuit together with the iron core;
a movable terminal having a movable contact configured to be moved corresponding to an activation of the electromagnet;
a fixed terminal having a fixed contact positioned opposed to the movable contact;
a coil terminal attached to the bobbin and connected to the coil;
an insulating member positioned between the coil and the yoke; and
a base having a wall configured to insulate between the coil terminal and the fixed terminal.

2. The relay according to claim 1, wherein the insulating member has a fitting part which fits in a lower flange part of the bobbin, and the insulating member contacts the bobbin only at the fitting part.

3. The relay according to claim 1, wherein at least one of the lower flange part and an upper flange part of the bobbin has a step part extending toward the yoke.

4. The relay according to claim 2, wherein a portion of the insulating member constituting the fitting part has a constant thickness.

5. The relay according to claim 1, wherein the insulating member has a protrusion extending in a substantially tangential direction of the coil, and a side of the protrusion facing the yoke has a recess.

6. The relay according to claim 1, wherein an upper end surface of the insulating member in an axial direction of the iron core is positioned farther from the contact than an upper end of the bobbin with respect to the axial direction of the iron core.

7. The relay according to claim 1, wherein a lower end surface of the insulating member in an axial direction of the iron core is positioned closer to the contact than a lower end of the bobbin with respect to the axial direction of the iron core.

8. The relay according to claim 1, wherein the insulating member has a protrusion extending in a substantially tangential direction of the coil, and a lower end of the protrusion has a tapered shape which narrows toward the iron core in a direction perpendicular to the axial direction of the iron core.

9. The relay according to claim 1, wherein the insulating member has a canopy which covers the upper flange part of the bobbin and does not contact the upper flange part.

10. The relay according to claim 9, wherein the canopy has a tapered shape which narrows toward the iron core.

11. The relay according to claim 1, wherein the wall of the base is formed adjacent to a hole formed in the base for the fixed terminal.
